(19) United States
(12) Patent Application Publication
(10) Pub. No.: US 2008/0005557 A1
(43) Pub. Date: Jan. 3, 2008

(54) Method of authentication and ownership verification of collectibles

(76) Inventor: James S. Chester, St. Petersburg, FL (US)

Correspondence Address: John Wiley Horton, Attorney;Pennington, Moore, Wilkinson, Bell & Dunbar, P.A., 2nd Floor, 215 S. Monroe St., Tallahassee, FL, 32301, US

(21) Appl. No.: 11/899,467

(22) Filed: Sep. 6, 2007

Related U.S. Application Data
(63) Continuation-in-part of application No. 10/246,128, filed on Sep. 16, 2002.

(51) Int. Cl. H04L 9/00

(52) U.S. Cl. 713/156; 713/155

(57) ABSTRACT

A secure method allowing the authentication of collectibles or other valuable items. The method affixes a unique and randomly generated identifying number to each item. A unique password is then associated with each identifying numbers. The set of identifying numbers and associated passwords are stored in random order in a registration database server. Public access to the system (for the beneficial use of transferees and authorized distributors) is provided through a public access server. The public access server communicates with a registration database server via random paths over the Internet. Thus, potential hackers do not have access to the true computing address of the registration database.

### BACKGROUND OF THE INVENTION

1. Field of the Invention.

This invention relates to the field of identity authentication. More specifically, the invention comprises a method for authenticating an item in commerce and verifying the ownership of the item.

2. Description of the Related Art.

Collectible items have been bought and sold for perhaps as long as commercial activity itself. This field has rapidly expanded in recent years, especially with the ascending popularity of sports memorabilia. Many such items are now very expensive, which makes them a desirable target for counterfeiters. With the advent of increasingly sophisticated duplicating technology, a purchaser's ability to distinguish a counterfeit item from the genuine article has been greatly compromised. Thus, those concerned with distributing legitimate collectibles have taken steps to ensure the authenticity of the collectibles.

One approach is to affix an authenticating label. Such a label preferably includes a holographic image or other distinguishing characteristic which is difficult to duplicate. The presence of the label assures the purchaser that the item to which the label is attached is authentic. A very sophisticated example of this approach is found in U.S. Pat. No. 6,646,771 to Stevenson (2003). The Stevenson disclosure describes an optical element including a primary and complementary hologram. Though conventional holograms are difficult to copy, a sophisticated counterfeiter can make a copy of a valid hologram which is virtually indistinguishable from the original. The '771 device—on the other hand—cannot be accurately copied since the known copying techniques cannot duplicate both the primary and complementary hologram. A copy of an authenticating label such as disclosed in the '771 patent would therefore be easily distinguished from the original.

The photopolymer disclosed in the '771 invention can include a secure identifying feature (such as an identifying sequence of numbers and letters). The identifying features are preferably embedded in the holographic images themselves. In that way, the identifying features cannot be altered without the alteration being readily apparent. Thus, the '771 device does allow secure authentication of a collectible.

Another problem recognized in the field of collectible transactions is the need to verify the transfer of a collectible between successive owners. This issue arises upon the original sale of the item and upon subsequent sales to new purchasers. One possible solution to this problem is disclosed in U.S. Pat. No. 6,591,252 to Young (2003). The Young invention associates a unique identifying code with each collectible. The ownership history of the item is then locked by linking the unique identifying code to a “Personal Identification Number” (“PIN”). The ownership history is stored in a computer database which cannot be accessed without the proper PIN.

Young's ownership history database is accessible by subsequent purchasers. Thus, it is made accessible to the public at large. To those unfamiliar with the computer security field, this public access may not appear to pose a problem (since one must have the PIN to make any alteration to the database). However, those skilled in the art will know that computer database hacking is a widespread problem. A “hacker” can use automated programs to compromise a database such as disclosed in Young. The hacker will use an automated program to submit every possible password to the computer system. An invalid password will return a message such as “access denied,” which informs the hacking program that the password just submitted is incorrect and prompts the submission of the next password in a large sequence of possibilities. Database systems such as employed in the Young invention include “firewalls” and other know security techniques but—as has too often been demonstrated—all these known techniques can be compromised.

A similar authentication system is disclosed in U.S. application Ser. No. 09/767,849 to Snow (Published Nov. 29, 2001 as Pub. No. US 2001/0047340 A1). Snow's FIG. 3 shows a typical interaction between a user (Customer web browser (46)) and an Internet-accessible database (44). The system includes typical security measures. However, since the authentication database is directly accessible to a hacker over the Internet, the security measures can again be compromised.

The reader will therefore appreciate that the prior art discloses authentication “tags” (such as disclosed in the '771 invention) which cannot be altered or counterfeited. The prior art also discloses on-line “registration” databases which can be used to verify the transfer of ownership. However, the existing registration databases can be compromised. The security they provide is therefore largely illusory.

### BRIEF SUMMARY OF THE INVENTION

The present invention comprises a secure method allowing the authentication of collectibles or other valuable items. The method affixes a unique and randomly generated identifying sequence to each item. A unique password is then associated with each identifying sequence. The set of identifying sequences and associated passwords are stored in random order in a registration database server. Public access to the system (for the beneficial use of transferees and authorized distributors) is provided through a public access server. The public access server communicates with a registration database server via random paths over the Internet. Thus, potential hackers do not have access to the true computing address of the registration database.

A legitimate user is allowed to log into the public access server and make change requests in the registration database (such as updating ownership information for a new transferee). The change requests are communicated from the public access server to the registration database server. Verifying responses are sent back to the public access server. However, those logging into the registration system can only interact with the public access server. The usual security breaching techniques—such as “auto worms”—cannot transfer one piece of knowledge (the identifying sequence) to gain access to the actual registration database since the two systems have different URL addressed that are not electronically or physically linked (other than by random paths over the Internet).

### BRIEF DESCRIPTION OF THE SEVERAL VIEWS OF THE DRAWINGS

FIG. 1 is a schematic view, depicting computers connected to a worldwide communication network.

FIG. 2 is a flowchart, depicting portions of the inventive method.

FIG. 3 is a schematic view, depicting the components of a typical computer.

FIG. 4 is a schematic view, depicting the interaction between public users of the system, the public access server, and the registration database server.

### REFERENCE NUMERALS IN THE DRAWINGS

| | | | |
|---|---|---|---|
| 10 | accrediting authority computer | 12 | accrediting authority |
| 14 | supplier computer | 16 | supplier |
| 18 | data communication link | 20 | retailer computer |
| 22 | retailer | 24 | consumer computer |
| 26 | consumer | 28 | processor unit |
| 30 | input device | 32 | output device |
| 34 | database | 40 | public users |
| 42 | Internet paths | 44 | public access server |
| 46 | Internet paths | 48 | registration database server |

### DESCRIPTION OF THE INVENTION

The present invention relates to a method for (1) authenticating and validating items or articles such as memorabilia, collectables or original works of art; and (2) registering and verifying the ownership and authenticity of such item or article transferred or exchanged between members of a distribution network. The system is preferably also used to verify ownership and authenticity during transfers from one purchaser to a subsequent purchaser.

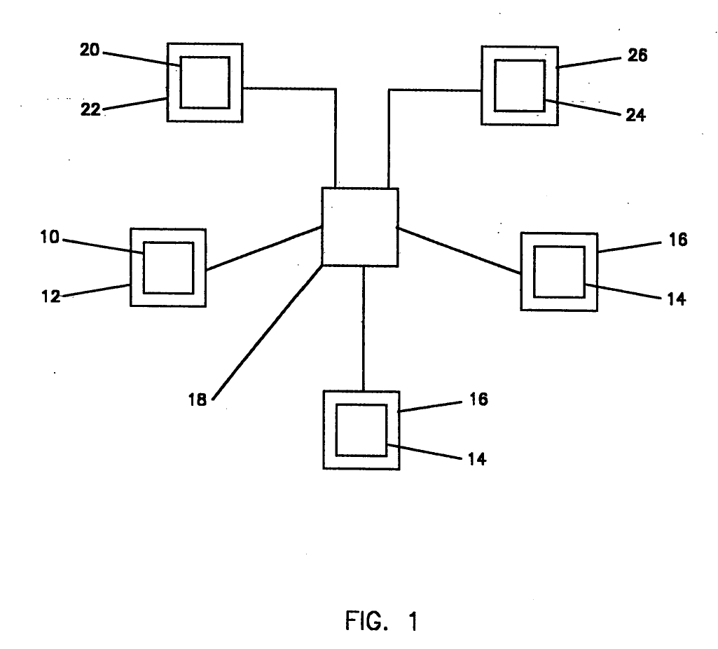

The invention contemplates the linking of multiple computers over a data exchange network. While the data link could be a dedicated hard line, the invention primarily contemplates the exchange of data over the worldwide communication network known as the Internet. FIG. 1 schematically depicts the linking of multiple computers over a data link. Accrediting authority computer 10 is located at accrediting authority 12. One or more authorized distributor or supplier computers 14 are located at one or more corresponding authorized distributors or suppliers 16. All these computers are connected by data communication link 18 capable of transferring data and information therebetween.

Accrediting authorizing computer 10 and authorized distributor or supplier computers 14 are also operatively linked to a retailer/network computer 20 located at one or more corresponding retailer/network facilities 22 and a consumer computer 24 located in the facility of one or more consumers 26. Retailer computer 20 can also be operatively coupled to the consumer computer 24 by data communication link 18. Consumer computers 24 may also be operatively coupled to one another by the data communication link 18.

Those skilled in the art will know that the most common data communication link now used is the worldwide communication network known as the Internet. The present inventive method could be implemented using communications other than the Internet. However, some of its main advantages stem from the use of the Internet, since data communication from computer to computer over the Internet can take a very large number of different paths. The invention takes advantage of this path-randomization to provide enhanced security.

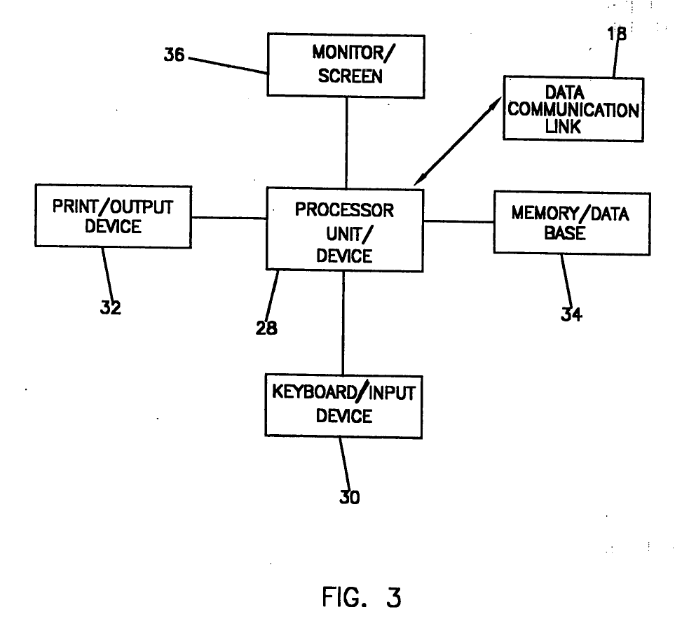

FIG. 3 depicts various elements which are well known to those knowledgeable in the field of computers. Each computer 10, 14, 20 and 24 (shown in FIG. 1) comprises a processor unit device 28 operatively coupled to a keyboard or other input device 30, a printer or other output device 32, a memory or data base 34 and a monitor or screen 36. As previously described, computers 10, 14, 20 and 24 are operatively coupled to each other through data communication link 18.

Each computer 10, 14, 20 and 24 includes information processing and storage capabilities or means to perform the various functions or sequential steps and communications over the data communication link 18 as described hereinafter. Software is of course used to execute the steps in the inventive method. A detailed description of the software itself is beyond the scope of this disclosure.

The system and method of the present invention comprises the steps of: (1) inspecting prospective distributors or suppliers prior to accreditation by the accrediting authority; (2) accrediting authorized distributors or suppliers by the accrediting authority; (3) issuing a unique identifier (such as a discrete photopolymer hologram) with embedded attributes with encrypted protection and password or personal identification sequence (preferably a number or “PIN”) and corresponding documentation including certificate of origin and certificate of authenticity to each authorized distributor or supplier for use with each separate item or article to be authenticated by each authorized distributor or supplier; (4) authenticating each item or article to be sold or transferred by each respective authorized distributor or supplier; (5) validating each item or article by applying the corresponding unique identifier thereto; (6) selling or transferring ownership of each authenticated item or article and issuing the corresponding certificate of authenticity including a unique alpha-numeric password to the transferee; (7) pre-registering with the accrediting authority transfer information including the name and address by transferring authorized distributor or supplier issuing and maintaining by the transferring distributor or supplier a certificate of origin including the name and address; (8) registering the item or article and respective owner with the accrediting authority upon receiving a request to register properly authenticated item or article by identity match with a password schema, electronic payment, update and promulgation of records and title information; (9) verifying the authenticity and ownership of a registered item or article by querying the accrediting authority; (10) transferring an item or article to a subsequent transferee; (11) issuing a new certificate of authenticity with a new unique password to the subsequent transferee; (12) registering the transferred item or article and subsequent transferee; and (13) auditing the facilities, procedures and records of authorized distributors and suppliers by the accrediting authority.

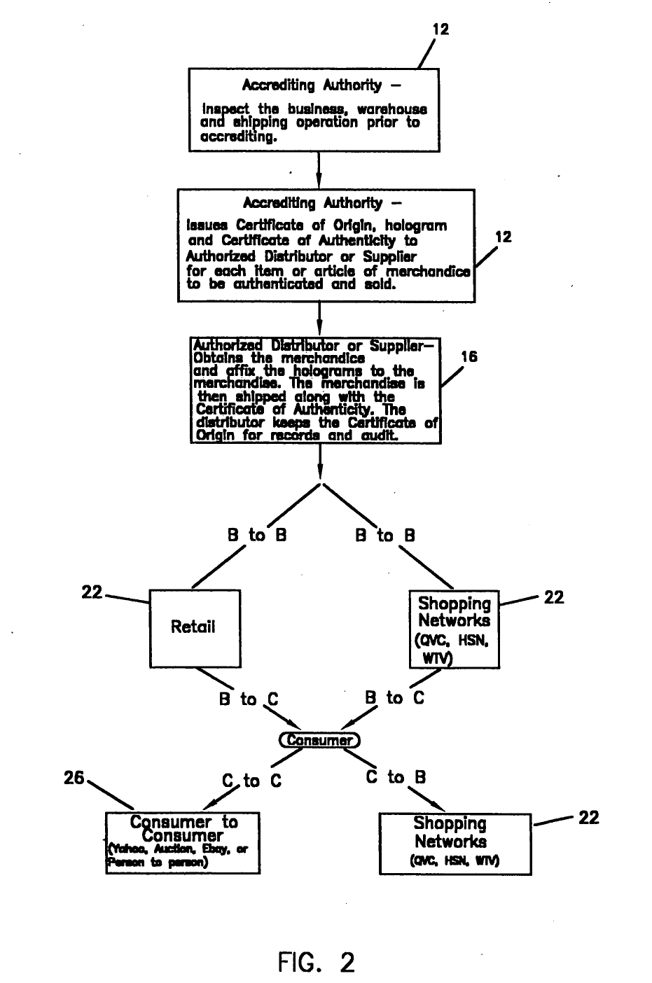

FIG. 2 shows a schematic representation of how the method applies to the transfer of items from a distributor, to a retailer, to a consumer, and ultimately on to other consumers in consumer-to-consumer transactions. Accrediting authority 12 inspects a business to ensure the security of its warehousing, shipping, and other operations. Once a business is accredited, the accrediting authority issues a Certificate of Origin, a unique identifier, and a Certificate of Authenticity for each item to be sold. The business (typically an authorized distributor or supplier) then transfers the item in a business-to-business transaction to a retailer 22 (such as a retail store, a television shopping network, or Internet retailer). These businesses then transfer the item to an initial consumer 26. Thereafter, the item may be sold from one consumer to another consumer. The registration system contemplated herein preferably includes all stages of this process.

In operation, the members of the trading environment are integrated with the accrediting authority. Only an authorized distributor or supplier can acquire, affix, record and provide the complex hologram, unique identifier and unique password for any particular item. Only the authorized distributor or supplier selling or transferring the particular item specific retains a corresponding certificate of origin for audit and record creation purposes. The location, identification, ownership and registration of authenticated items is maintained by the accrediting authority.

Authorized distributors access the trading environment over the data communication link 18. The accrediting authority provides secured access to an authentication database for the authorized distributors, as will be explained in more detail subsequently. When a new item is to be registered, an authorized supplier provides unique identification and password information (previously furnished by the accrediting authority) to the accrediting authority. This allows the supplier to open a secure pre-registration and management session. Database integrity and security extends to all field components with limited modification or alteration privileges being provided to the supplier. The accrediting authority assigns the appropriate fields and particular identifier information for type, item, and requisite autograph assignee (in the case of an autographed piece of memorabilia).

Verification and/or title transferee information is also accessed through the trading environment over data communication link 18. This portion of the inventive method includes several important novel features. Accrediting authority 12 provides a secure search field for title search and ownership verification. The unique serial number and categorization is assigned once to each item or article to complete the electronic “birthmark” in association with the physical birthmark (the unique identifier) affixed and recorded by the authorized distributor or supplier.

The unique identifier could comprise a sequence of numbers, letter, symbols, or combinations thereof. However, as it is conventional to use a sequence of numbers, numerical sequences will be discussed in the examples disclosed.

A legitimate user of the system will have a unique serial number identifying an item. The user accesses the system over the Internet and enters the unique serial number into a search field. The system then queries record files for the correct information and presents the current owner by name and a graphical image representation of the particular item is displayed.

Registration of the title transferee is accomplished through a separate field within the trading environment. The prospective registrant or transferee (a consumer 26) accesses the secure interface over data communication link 18. The registration field requires the prospective registrant to enter both a serial number and unique password to gain access to the secure registration environment. The trading environment then makes a request of the master database file to verify serial number and matching unique password information. Incorrect information immediately halts attempted access and returns the prospective registrant to the initial field. Once authenticated, the prospective registrant is required to enter location and contact information in concert with electronic payment credentials for record registration and maintenance. Once payment credentials are verified and debited over a secure authentication provider, title transference is accomplished over an immediate update of the master database with associated electronic serial number and title owner.

The method of the present invention is embodied in a secure delivery environment including at least two servers. These servers include multiple computing and storage devices on which reside multiple applications for the protection, interrogation, querying, cataloging, recording, recall, display, and modification of trading environment information. These servers also include secure access for electronic funds verification and collection. These servers are physically and electronically protected from fraudulent access and interrogation over complex location and access schemas enabled through the switching and firewall environments (as will be explained in more detail subsequently). Furthermore, the master databases and financial information are maintained on a separate network completely isolated from the public Internet.

If improper or incorrect information or data is entered or not verified by the master database, the requestor is notified to return to the previous screen for correct information entry over a secure back path. Alternative paths do not exist to allow any access to the master database and financial files. Physical and electronic separation is maintained for all databases and queries.

All transactions and queries are monitored and protected by a combination of physical and electronic methods to ensure environment integrity. While linkages may be made to the environments, no direct database access or permanent record modifications can be made. Network, password, firewall, and database encryption techniques are used in combination to ensure environment integrity.

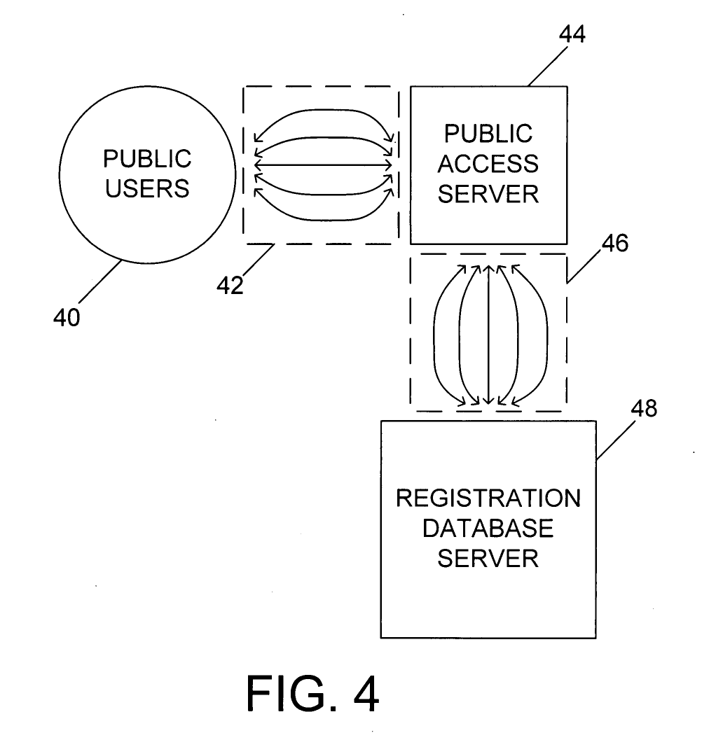

FIG. 4 shows a schematic depiction of one particular embodiment. As stated previously, the provision of multiple separate servers increases the system's security. Access must be provided to suppliers, retailer, consumers, and others needing to utilize the system. These are graphically depicted in the view as public users 40. Access is preferably provided over the Internet. Thus, public access server 44 is established at a first URL (Uniform Resource Locator) address on the Internet. The public users may therefore access public access server 44 by opening a web browser running on their own computers and entering the specified URL for public access server 44. The link between a public user and public access server 44 will therefore assume random paths over the Internet (labeled as 42 in the view). As those skilled in the art will know, these random paths will vary continually, and are beyond the control of both the public users and the public access server (and therefore likewise beyond the control of any potential hacker).

Registration database server 48 is a second independent server established at a second URL address. It is preferably isolated from public access server 44, with the only communication between the two occurring over the Internet. Each server is provided with the URL of the other, so that they may communicate. However, these communications will also assume random and continually changing paths over the Internet (labeled as 46 in the view).

The system architecture depicted in FIG. 4 is different from prior art systems. Older authentication systems providing authentication over the Internet are vulnerable to hacking. This is true because a database of identifying numbers cross-referenced to passwords is stored on the publicly-accessible system. A hacker can use a program which runs through a huge sequence of identifying numbers and passwords. Prior art systems will transmit a message such as “access denied” when no match is found. The hacking program then submits the same identifier with additional passwords until a “hit” is found. Such prior art systems use firewalls and other known techniques, but all these have been shown to be vulnerable.

The new method overcomes the vulnerability of the prior art by using a new approach. It isolates the authentication database from the system which provides public access to the users over the Internet. While many schemes could be used for the authentication database, it is preferably created as follows: A random number generator is used to create a unique identifying number. The generator is configured to never generate the same random number twice (Once a number is generated, it is eliminated from the set of possible random numbers). A large sequence is used, which is scalable into the tens of trillions. Thus, even though many numbers will be eliminated having been previously generated, a sufficient quantity of additional “possible” numbers will remain available. The generator also randomizes the sequencing of the identifying numbers and associated passwords in the database. Assume, as an example, that the numbers 0002245144, 0324458701, 1040535762, and 2297340230 are created. If these numbers were put in numerical sequence in a database, they would appear as:

$$0002245144$$

$$0324458701$$

$$1040535762$$

$$2297340230$$

Instead, the present method would place them randomly in the database. They might then appear as follows:

$$1040535762$$

$$0002245144$$

$$2297340230$$

$$0324458701$$

A unique password is associated with each identifying number. A sample of the database might then look like:

| Identifying Number | Password |
|---|---|
| 1040535762 | tho11488 |
| 0002245144 | as506fg1 |
| 2297340230 | csa443ir |
| 0324458701 | wt104tc7 |

Of course, the database will consist of millions of entries. However, because of the randomization, they will not appear in any defined numerical sequence. When the authentication computer needs to query the database, it will have to scan the entire database until the desired unique identifying number is found (since the lack of numerical ordering will not allow the system to “zoom in” on the right portion of the list). While this may seem disadvantageous, the speed of modern computers allows rapid scanning of a huge list—even with the randomization.

If a hacker system (or legitimate user) enters a nonexistent identifying number, the system will return a message saying “no match for that record” (or a similar message having the same meaning). Likewise, if a legitimate identifying number is entered, but with an incorrect password, the system will also say “no match for that record.” A hacker therefore will not know whether he has found a legitimate identifying number (and can therefore start bombarding the system with a sequence of possible passwords) or instead entered an undefined identifying number.

The present invention also employs a significantly different arrangement for storing and accessing the authentication database, shown in FIG. 4. Public access server 44 has a conventional Graphical User Interface (“GUI”) which is accessible over the Internet. A person needing to authenticate an item interacts with the public access server (using random paths over the Internet). As disclosed previously, the public access server does not actually contain the authentication database, nor is it directly connected to the system that does. Instead, the registration database server is provided at a second URL (and possibly a second physical location). The only connection between the public access server and the registration database server is the fact that both are connected to the Internet. Thus, communications between the two will take random paths over the Internet (labeled as 46 in FIG. 4).

In operation, a user would log into the public access server over the Internet and submit a unique identifying number and its (alleged) associated password (with the term “alleged” indicating that at the time the password is collected, its authenticity is unknown). The public access server then creates an instance search operation and sends a query over the Internet to the registration database server. The registration database server then sends back the appropriate message (such as “authentic” or “no match for that record”). If a “no match for that record” message is received by the public access server, it breaks the connection with the user (logs the user out of the public access server). Since a new (and random) connection must then be reestablished over the Internet, it will be very difficult for a hacker to bombard the public access server with a progression of possible identifier/password combinations. Each search initiated by a user causes the public access server to create a new and unique search task. There is no possibility of a public user gaining direct access to the registration database. Thus, as will be realized by those skilled in the art, conventional hacking techniques will not work.

The reader should note that each class of product can be assigned a range of potential random numbers. As an example, sports memorabilia could be assigned numbers 000000000 through 100000000. A user could be required to submit a description of the type of product—possibly selected from a list—along with the identifying number and password. If the identifying number is in the wrong range, then no search would even be initiated by the public access server.

The public access server can be configured to perform other related operations. As an example, it is anticipated that a transferee wishing to update the information in the registration database will be charged a fee. The public access server can provide information regarding this fee and can collect payment data (such as a credit card transaction). This transaction can also be accommodated by a third server configured to store secure data such as credit card information.

The reader will thereby understand that the present inventive method provides an authentication and verification system which prevents counterfeiting and which resists compromises of the secure database. However, the system remains easily accessible to authorized users over the Internet.

The preceding descriptions have provided considerable detail regarding certain embodiments of the invention. However, the embodiments disclosed should properly viewed as exemplary, rather than as an exhaustive listing. Numerous other embodiments of the present invention are possible, and are readily understood by those skilled in the art (having read the preceding disclosure). Thus, the scope of the invention should be fixed by the following claims, rather than by the examples given.

Having described my invention, I claim:

1. A method of authenticating and validating, registering and verifying the authenticity and ownership of items transferred between members of a distribution network including an accrediting authority, authorized distributor(s), and transferee(s) of the authentic items, comprising:
a. providing an accrediting authority to authorize distributors to sell authenticated items;
b. having said accrediting authority authorize distributors to sell authenticated items;
c. authenticating and validating each item with an identifier including a randomly generated and unique identifying sequence;
d. transferring said items bearing said unique identifiers from one of said authorized distributors to a transferee;
e. providing a registration system so that each transferee can register each of said items with said accrediting authority and verify the authenticity of each of said items, wherein said registration system includes
i. a public access server, providing a data communication link between said accrediting authority, said authorized distributors, and said transferees over a world wide communication network, wherein said data communication link is accessible by anyone on said world wide communication network,
ii. a registration database server, in communication with said public access server only via said world wide communication network, and
iii. a registration database available only to said registration database server, wherein said registration database includes a unique password associated with each unique identifying sequence, with said unique passwords and said unique identifying sequences being stored in a random sequence within said registration database.

2. The method of claim 1 wherein said authorized distributors are inspected prior to accreditation by said accrediting authority.

3. The method of claim 2 wherein there is periodic auditing of authorized distributors and suppliers by the accrediting authority.

4. The method of claim 1 wherein each item is pre-registered with the accrediting authority by the transferring authorized distributor.

5. The method of claim 1, wherein said unique identifier is embedded within a hologram affixed to each item.

6. The method of claim 1 wherein a certificate of authenticity is issued for each item.

7. The method of claim 1 wherein a certificate of origin is issued and maintained by the transferring authorized distributor for each item.

8. The method of claim 1, further comprising:
a. receiving a request to register a transfer of an item from a transferee, said request including an alleged unique identifier and unique password associated with said item, said request being received by said public access server over said world wide communication network;
b. transmitting said request from said public access server to said registration database server over said worldwide communication network;
c. within said registration database server, checking said alleged unique identifier and unique password against said registration database; and
d. in the event that said alleged unique identifier and unique password are authenticated, allowing said transferee to update ownership information contained within said registration database.

9. The method of claim 1 wherein the authenticity and ownership of a registered item may be verified by querying said accrediting authority.

10. The method of claim 9 wherein an item is transferred to a subsequent transferee.

11. The method of claim 10 wherein a new certificate of authenticity is issued to the subsequent transferee with a new unique identifier for each item or article.

12. The method of claim 11 wherein the item or article is registered and transferred to the subsequent transferee.

13. The method of claim 4 wherein a request to register a properly authenticated item and verification of identity are matched with an encryption schema, electronic payment, updated and promulgation of records and title information to each transferee.

14. The method of claim 13 wherein a certificate of authenticity is issued for each item.

15. The method of claim 14 wherein a certificate of origin is issued and maintained by the transferring authorized distributor for each item.

16. The method of claim 14 wherein the authenticity and ownership of a registered item may be verified by querying said accrediting authority.

17. The method of claim 16 wherein an item is transferred to a subsequent transferee and the item is registered and transferred to the subsequent transferee.

18. The method of claim 17 wherein a new certificate of authenticity is issued to the subsequent transferee with a new unique identifier for each item.

19. The method of claim 5 wherein a certificate of authenticity is issued for each item.

20. The method of claim 19 wherein each item is pre-registered with said accrediting authority by said transferring authorized distributor.

21. A method of verifying the authenticity and ownership of an item transferred between a transferor and a transferee of said item, comprising:
a. providing a unique identifier including a randomly generated and unique identifying sequence;
b. at some point associating said unique identifier with said item;
c. after said unique identifier has been associated with said item, transferring said item from said transferor to said transferee;
d. providing a registration system so that said transferee can register said transfer from said transferor within said registration system, wherein said registration system includes
i. a public access server, providing a data communication link between said transferor, said transferee, and said registration system via random paths over a world wide communication network, wherein said data communication link is accessible by anyone on said world wide communication network,
ii. wherein said public access server accepts said unique identifying sequence and an associated alleged password,
iii. a registration database server, in communication with said public access server via random paths over said world wide communication network,
iv. a registration database available only to said registration database server, wherein said registration database includes a list of unique passwords associated with each of said unique identifying sequences,
v. wherein when said public access server receives said unique identifier and said associated alleged password, said public access server creates a new task which transmits a single unique identifier and said associated alleged password to said registration database server via a random path over said world wide communication network,
vi. wherein when said registration database receives said new task from said public access server, said registration database server performs an authenticity check of said unique identifier and said associated alleged password against said registration database to determine if it is correct, and
vii. wherein said registration database sends a message back to said public access server via a random path over said world wide communication network, with said message indicating the result of said authenticity check.

22. A method as recited in claim 21, wherein said registration database includes said unique identifying sequences and said associated passwords being stored in a random sequence.

23. The method of claim 21, wherein said unique identifier is embedded within a hologram affixed to each item.

24. The method of claim 21 wherein a request to register a properly authenticated item and verification of identity are matched with an encryption schema, electronic payment, updated and promulgation of records and title information to each transferee.

25. The method of claim 21 wherein a certificate of authenticity is issued for each item.
